(19) United States
(12) Patent Application Publication
(10) Pub. No.: US 2001/0031232 A1
(43) Pub. Date: Oct. 18, 2001

(54) Method for disposing of metal cations

(76) Inventor: Horst-Otto Bertholdt, Forchheim (DE)

Correspondence Address: LERNER AND GREENBERG, P.A., PATENT ATTORNEYS AND ATTORNEYS AT LAW, Post Office Box 2480, Hollywood., FL, 33022-2480, US

(21) Appl. No.: 09/854,261

(22) Filed: May 10, 2001

Related U.S. Application Data
(63) Continuation of application No. PCT/DE99/03405, filed on Oct. 25, 1999.

(30) Foreign Application Priority Data
Nov. 10, 1998 (DE) 198 51 850.1

(51) Int. Cl. B01D 11/00

(52) U.S. Cl. 423/54; 588/249; 423/139

(57) ABSTRACT

A method for disposing of metal cations includes binding them to a cation exchange resin. The valence of the metal which forms the metal cations is lowered to the lowest possible value. The metal cations, the metal of which has the lowest possible valence, are then bound to the cation exchange resin. The valence of the metal is lowered, for example, by reduction, for which purpose, by way of example, an organic compound together with UV irradiation is used.

### CROSS-REFERENCE TO RELATED APPLICATION

This application is a continuation of copending International Application No. PCT/DE99/03405, filed Oct. 25, 1999, which designated the United States.

### BACKGROUND OF THE INVENTION

Field of the Invention

The invention relates to a method for disposing of metal cations by binding them to a cation exchange resin.

In customary decontamination processes, metal cations are produced and have to be disposed of. These cations, which are often cations of dissolved corrosion products, are continuously bound to ion exchange resins. However, they may also be cations which are derived from protective layers which are no longer required. Such protective layers are necessary to prevent attack on the base metal during decontamination. The cations may also be radioactive.

A cleaning method which is used in particular for decontaminating the surface of a metallic component is known from German Patent DE 41 17 625 C2. This method involves, inter alia, metal cations from a solution being bound to cation exchange resin, in order to regenerate cleaning chemicals. Before doing so, iron(III) is reduced to form iron(II), since the iron(III) cannot be completely removed from the solution. This is therefore a matter of regenerating the cleaning chemicals.

### SUMMARY OF THE INVENTION

It is accordingly an object of the invention to provide a method for disposing of metal cations that overcomes the disadvantages of the prior art methods of this general type and which uses significantly less cation exchange resin than has heretofore been customary. Therefore, the aim is to improve the capacity of the cation exchange resin, so that less laden cation exchange resin which has to be disposed of as waste is produced than has heretofore been the case.

With the foregoing and other objects in view there is provided, in accordance with the invention, a method for disposing of at least one metal cation by binding to a cation exchange resin, comprising the steps of lowering the valence of the metal cation to the lowest possible value for the metal, and binding the metal cation or cations to the cation exchange resin with the metal cation or cations in the lowest possible valence stable in water.

The invention is based on the finding that more of a metal cation can be bound to the same quantity of cation exchange resin if the valence of the metal of the metal cation is lower. This has the advantage that less cation exchange resin needs to be used to bind the same quantity of metal cations, provided that, as provided in the method according to the invention, the valence of the metal is lowered to the lowest possible value stable in water. Since less laden cation exchange resin is produced, this has the advantage that less final storage capacity is required for the used resins.

By way of example, 50% less resins are required if a divalent metal is converted into a monovalent metal. 33% less resins are required if a trivalent metal is converted into a divalent metal. The result is a clear saving.

In accordance with the invention, the valence of the metal is lowered to the lowest valence stable in water, for example, by reduction of the metal cations in a solution. Cations of more than one metal can be treated at the same time. A chemical process of this type is relatively simple to carry out.

By way of example, to reduce the metal cations an organic compound is added to the solution and then the solution is irradiated with UV light.

Particularly suitable organic compounds are ethylenediaminetetraacetic acid (EDTA) or picolinic acid. It is also possible to use a mixture of these acids.

By way of example, the method may be carried out in such a way that the organic compound is regenerated while the metal cations are being bound to the cation exchange resin and can be reused in a circulating process. This has the particular advantage that the organic compound, e.g. EDTA, does not have to be constantly topped up. A relatively small quantity of organic compound is sufficient.

The metal of the metal cations is, for example, iron, nickel and/or chromium.

The metal is in particular iron which is initially at least partially trivalent. The trivalent iron is then converted into divalent iron.

Oxide layers which are to be removed often contain, in addition to divalent nickel and trivalent chromium, iron in two stable valencies, namely divalent and trivalent. Iron is the principal constituent of such layers. The proportion of trivalent iron in a layer of oxides can be greater than 90%, depending on the type of nuclear power plant which is to be decontaminated. As a result, simply by converting trivalent iron into divalent iron, the quantity of waste which has to be disposed of is reduced by approximately 30%. There is a consequent advantageous saving of 30% of the cation exchange resin, so that a significantly smaller final storage volume is sufficient.

The method according to the invention achieves the particular advantage that less cation exchange resin has to be disposed of, and also that the resulting metal cations of the lower valence are more firmly bound to the resin, which reduces the likelihood of a breakout from the cation exchange resin. Consequently, the leakage of cations through the cation exchanger is also reduced. Finally, the cleaning time for a plant, which also includes the time required for removal of cations from a used solution, is significantly shortened. The downtime of a plant, in particular a nuclear power plant, for decontamination purposes is advantageously shorter than has previously been the case.

Other features which are considered as characteristic for the invention are set forth in the appended claims.

Although the invention is described herein as embodied in a method for disposing of metal cations, it is nevertheless not intended to be limited to the details given, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

The following text lists the individual chemical reactions which take place during the method according to the invention, with reference to an example. This example explains how the cations of trivalent iron are removed:

In a nuclear power plant, oxides of trivalent iron can be present in a layer which is contaminated or in a protective layer.

First of all, an organic compound of the trivalent iron, which is in aqueous solution, is formed from an oxide of trivalent iron of this type, through the use of an organic compound, for example through the use of EDTA. Consequently, cations of the trivalent iron form a constituent of the solution.

In a second step, the solution of the organic compound of trivalent iron is irradiated with UV light. As a result, a solution of an organic compound of divalent iron and carbon dioxide, which is discharged, is formed. UV irradiation for the reduction of iron is disclosed in EP 0 753 196 B1.

In a third step, the solution of an organic compound of divalent iron which is now present is passed over a cation exchange resin, where the cations of divalent iron are bound. What remains is the organic compound, e.g. EDTA, which was used in the first step. In a circulating process, the organic compound formed in the third step can be reused for the first step, if further oxides of trivalent iron are to be eliminated.

When all of the oxides of the trivalent iron have been eliminated, a small quantity of the organic compound remains. This can be broken down using known processes, for example using the process described in EP 0 527 416 B1. Otherwise, all that remains is water, carbon dioxide and a quantity of cation exchange resin which is significantly smaller than with known methods and contains only cations of divalent iron.

Advantageously, so little cation exchange resin is produced that a small final store is sufficient.

I claim:

1. A method for disposing of at least one metal cation, which comprises the steps of:
lowering a valence of a metal cation to a lowest possible value for the metal; and
binding the metal cation, the metal of which has the lowest possible valence, to a cation exchange resin.

2. The method according to claim 1, which further comprises lowering the valence of the metal by reduction of the metal cation in a solution.

3. The method according to claim 2, which further comprises adding an organic compound reducing agent to the solution and irradiating the solution with UV light.

4. The method according to claim 3, which further comprises selecting the organic compound from the group consisting of ethylenediaminetetraacetic acid (EDTA) and picolinic acid.

5. The method according to claim 3, which further comprises regenerating the organic compound while the metal cations are being bound to the cation exchange resin and reusing the organic compound in a circulating process.

6. The method according to claim 1, which further comprises selecting the metal from the group consisting of iron, nickel and chromium.

7. The method according to claim 6, wherein the metal is initially at least partially trivalent iron.

8. The method according to claim 1, which further comprises binding cations of a plurality of metals to the cation exchange resin.

9. The method according to claim 1, wherein at least 90% of the metal cation is iron.
